(19) United States
(12) Patent Application Publication
(10) Pub. No.: US 2008/0151716 A1
(43) Pub. Date: Jun. 26, 2008

(54) OPTICAL DISC RECORDING AND REPRODUCING APPARATUS AND OPTICAL DISC RECORDING AND REPRODUCING METHOD

(75) Inventors: Yukiyasu TATSUZAWA, Yokohama-Shi (JP); Koichi Otake, Yokohama-Shi (JP); Hideyuki Yamakawa, Kawasaki-Shi (JP); Toshihiko Kaneshige, Yokohama-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/964,511

(22) Filed: Dec. 26, 2007

(30) Foreign Application Priority Data
Dec. 26, 2006 (JP) 2006-350273

(51) Int. Cl. G11B 7/00; G11B 20/18; G11B 27/36

(52) U.S. Cl. 369/53.15

(57) ABSTRACT

An optical disc recording and reproducing apparatus which reproduces data by the PRML scheme includes a recording waveform generating unit for generating a recording waveform, a reproducing unit for reproducing the recorded data to generate reproduction data, a defect determining unit for determining whether or not a defect is included in a reproduction signal, a reproduction state determining unit for determining whether or not the reproduction state is stable, and a recording learning unit for performing recording learning for determining a parameter of a recording waveform on the basis of the reproduction data. The recording learning unit performs the recording learning on the basis of the reproduction data acquired when the reproduction state is stable.

### CROSS-REFERENCE TO RELATED APPLICATIONS

This application claims the benefit of priority of Japanese Patent Application No. 2006-350273, filed Dec. 26, 2006, the entire contents of which are incorporated herein by reference.

### BACKGROUND

1. Field

The present invention relates to an optical disc recording and reproducing apparatus, and an optical disc recording and reproducing method. More specifically, the present invention relates to an optical disc recording and reproducing apparatus and an optimal disc recording and reproducing method using the PRML scheme.

2. Description of the Related Art

In recent years, HD DVD players and recorders using the HD DVD standard, which is a standard for a high-capacity optical disc designed for reproduction of HD (High Definition) video, have come onto the market. This HD DVD uses a blue-violet laser at a wavelength of 405 nm for recording and reproduction, and the read-only HD DVD-ROM standard has 15 GB recording capacity on one side and one layer, 30 GB on one side and two layers.

Once-writable HD DVD-R also has a recording capacity of 15 GB on one layer, 30 GB on two layers. Further, re-writable HD DVD-RAM has a recording capacity of 20 GB on a single layer alone.

In order to realize such a large capacity, the HD DVD standard not only uses a shorter laser wavelength but also adopts a technique called the PRML scheme as a signal processing scheme for data reproduction. Although the PRML technique itself is a known technique, an overview of this technique will be given below.

In a reproduction process using the partial response (PR) scheme, data is reproduced by positively utilizing intersymbol interference (interference between reproduction signals corresponding to adjacent recorded bits) while compressing a necessary signal bandwidth. The partial response (PP) can be further classified into a plurality of classes depending on the way intersymbol interference is generated. For example, in class 1, reproduction data is reproduced as 2-bit data “11” with respect to recording data “1”, and intersymbol interference is generated with respect to the subsequent one bit.

On the other hand, ML is a kind of so-called maximum likelihood sequence estimation schemes, in which data is reproduced on the basis of information of signal amplitudes at a plurality of points in time by effectively utilizing the intersymbol interference rules of a reproduction waveform. In many cases, a Viterbi decoding scheme is used as the maximum likelihood sequence estimation scheme.

A synchronous clock synchronized with a reproduction waveform obtained from an optical disc is generated, and the reproduction waveform itself is sampled using this clock and converted into amplitude information. Thereafter, the amplitude information is subjected to appropriate waveform equalization to be converted into a predetermined partial response waveform. A Viterbi decoding unit then outputs the most likely data sequence as reproduction data using old and current sample data.

A combination of the partial response scheme and Viterbi decoding scheme (most likelihood decoding) is called the PRML scheme. Putting this PRML technique into practical use requires a high-precision adaptive equalization technique for making a reproduction signal be a response of a predetermined PR class, and a high-precision clock reproduction technique that supports this technique.

A run length limited code used in the PRML scheme will be described below. A reproduction circuit using the PRML scheme generates, from a signal reproduced from an optical disc itself, a reference clock synchronized with this signal by using a PLL circuit, for example. In order to generate a stable clock, the polarity of a recording signal needs to be reversed within a preset period of time. At the same time, to lower the maximum frequency of a recording signal, it is necessary to ensure that the polarity of the recording signal be not reversed during a preset period of time. The maximum data length within which the polarity of a recording signal does not reverse is referred to as a maximum run-length, and the minimum data length within which the polarity does not reverse is referred to as a minimum run-length.

For example, a modulation rule with the maximum run-length of 7 bits and the minimum run-length of 2 bits is called (1, 7) RLL. In (1, 7) RLL code, since minimum mark or space length Tmin is 2T, (1, 7) RLL code is generally referred to as 2T code. Further, a modulation rule with the maximum run-length of 7 bits and the minimum run-length of 2 bits is called (2, 7) RLL. In (2, 7) RLL code, since minimum mark or space length Tmin is 3T, (2, 7) RLL code is likewise referred to as a 3T code.

Typical modulation/demodulation schemes used for an optical disc include 2T-code ETM modulation adopted for HD DVD, and 3T-code 8/16 modulation (EFM Plus) adopted for DVDs of the related art.

In the case of a recording and reproducing apparatus employing the PRML scheme, a considerable improvement in performance is expected even with respect to a high-density recording optical disc for which satisfactory reproduction performance cannot be readily attained with the binary slice method used in the related art. For this reason, the HD DVD standard adopts the PRML scheme to achieve high linear recording density.

On the other hand, processes performed when recording data onto an optical disc include generation of an optimum recording waveform. Normally, when forming a single continuous recording mark on an optical disc, the recording layer of the optical disc is irradiated with laser light modulated by a recording waveform including a plurality of short pulse strings. The recording waveform for forming a proper recording mark varies slightly due to a difference in the kind of an optical disc or the like. Accordingly, a process is performed in which a standard recording waveform is corrected in accordance with a difference in the kind of an optical disc or the like to generate an optimum recording waveform. This process is referred to as a recording compensation process.

A recording compensation process in itself is also performed in the binary slice scheme of the related art. In this regard, JP-A 2003-151219 discloses a technique that makes it possible to realize a recording compensation process also with respect to an optical disc recording and reproducing apparatus adopting the PRML scheme.

According to the technique disclosed in JP-A 2003-151219, a plurality of predetermined data string patterns are recorded onto an optical disc in a reference recording waveform (recording waveform as an initial value), and the recorded data string patterns are reproduced to calculate an index called a recording compensation amount Ec. Parameters of a recording waveform (for example, the pulse widths of the leading and trailing pulses of a plurality of pulses) are corrected on the basis of this recording compensation amount Ec, and the above-mentioned data string patterns are recorded onto the optical disc again in the corrected recording waveform. This cycle is repeated until the recording compensation amount Ec converges to a predetermined value, for example, zero, thereby determining an optimum recoding waveform.

As described above, in the technique disclosed in JP-A 2003-151219, “recording learning” is performed, whereby data is actually recorded onto an optical disc, and the recorded data is reproduced to determine an optimum recording waveform.

To perform recording learning properly, the reproduction process must be performed in a stable state during the recording learning period, particularly during the reproducing period of recorded data. If, for example, recording learning is performed in an unstable state such as during lock-off or pull-in of the PLL circuit, erroneous learning result is obtained, which makes it impossible to obtain an optimum recording waveform.

### SUMMARY OF THE INVENTION

The present invention has been made in view of the circumstances mentioned above. Accordingly, it is an object of the present invention to provide an optical disc recording and reproducing apparatus and an optical disc recording and reproducing method which make it possible to acquire data required for recording learning in a stable reproduction state at all times, when applied to an optical disc recording and reproducing apparatus in which optimum parameters of a recording waveform with respect to an optical disc are determined by recording learning.

To solve the above-mentioned problems, according to a first aspect of the present invention, there is provided an optical disc recording and reproducing apparatus which records data onto an optical disc and reproduces the data by a PRML scheme, including: a recording waveform generating unit for generating a recording waveform for recording the data onto the optical disc; a reproducing unit for reproducing the data recorded on the optical disc to generate reproduction data; a defect determining unit for determining whether or not a defect is included in a reproduction signal of the optical disc; a reproduction state determining unit for determining whether or not a reproduction state of the reproducing unit is stable; and a recording learning unit for performing recording learning for determining, on the basis of the reproduction data, a parameter of a recording waveform generated by the recording waveform generating unit. The recording learning unit performs the recording learning on the basis of the reproduction data acquired when no defect is included in the reproduction signal and the reproduction state is stable.

To solve the above-mentioned problems, according to a second aspect of the present invention, there is provided an optical disc recording and reproducing method for recording data onto an optical disc and reproducing the data by a PRML scheme, including the steps of: (a) generating a recording waveform for recording the data onto the optical disc; (b) reproducing the data recorded on the optical disc by a reproducing unit to generate reproduction data; (c) determining whether or not a defect is included in a reproduction signal of the optical disc; (d) determining whether or not a reproduction state of the reproducing unit is stable; and (e) performing recording learning for determining, on the basis of the reproduction data, a parameter of a recording waveform generated by the step (a). In the step (e), the recording learning is performed on the basis of the reproduction data acquired when no defect is included in the reproduction signal and the reproduction state is stable.

With the optical disc recording and reproducing apparatus and the optical disc recording and reproducing method according to the present invention, in an optical disc recording and reproducing apparatus in which optimum parameters of a recording waveform with respect to an optical disc are determined by recording learning, data required for recording learning can be acquired in a stable reproduction state at all times.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing an example of configuration of an optical disc recording and reproducing apparatus according to a first embodiment of the present invention;

FIG. 2 is a diagram showing an example of detailed configuration of an adaptive equalizer unit;

FIGS. 3A and 3B are diagrams schematically showing the relationship between a recording data string and a recording waveform;

FIGS. 4A and 4B are diagrams illustrating the calculation principle for a recording compensation amount Ec;

FIGS. 5A to 5D are diagrams exemplifying the kinds of data string pattern for which recording learning is performed, and corresponding recording waveform parameters (pulse widths);

FIG. 6 is a diagram showing an example of operation principle of a defect determining unit;

FIGS. 7A to 7D are diagrams illustrating operation of a reproduction state determining unit;

FIG. 8 is a diagram showing an example of configuration of an optical disc recording and reproducing apparatus according to an embodiment in which sequence control is performed;

FIGS. 9A and 9B are diagrams illustrating units in which data for recording learning is recorded;

FIGS. 10A to 10H are diagrams illustrating an operation example of sequence control;

FIG. 11 is a diagram showing an example of configuration of an optical disc recording and reproducing apparatus according to an embodiment in which learning of recording power is performed;

FIGS. 12A to 12I are first diagrams illustrating an operation example of sequence control in an embodiment in which sequential measurement is performed (the case of normal termination); and

FIGS. 13A to 13I are second diagrams illustrating an operation example of sequence control in an embodiment in which sequential measurement is performed (the case of abnormal termination).

### DETAILED DESCRIPTION

An optical disc recording and reproducing apparatus, and an optical disc recording and reproducing method according to an embodiment of the present invention will be described with reference to the attached drawings.

### (1) FIRST EMBODIMENT

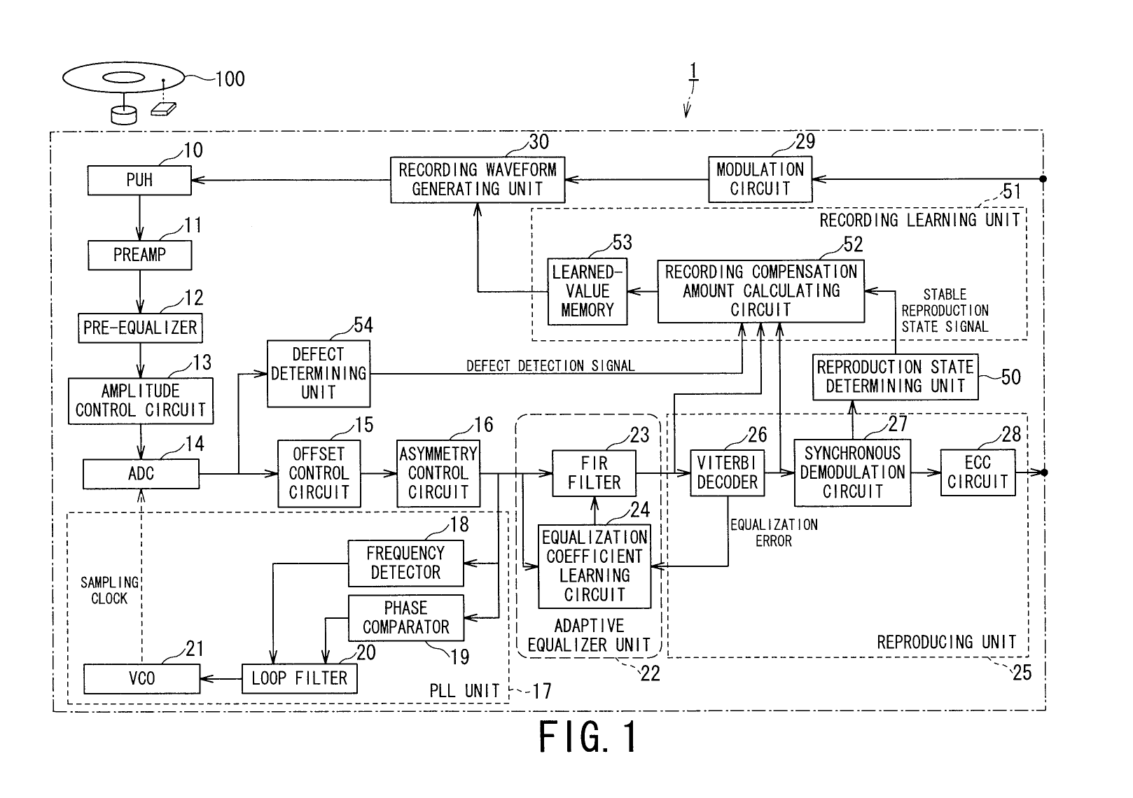

FIG. 1 is a diagram showing an example of configuration of an optical disc recording and reproducing apparatus 1 according to a first embodiment of the present invention. The optical disc recording and reproducing apparatus 1 is roughly divided into a reproducing system for reproducing data recorded on an optical disc 100, a recording system for recording data onto the optical disc 100, and a recording learning system according to this embodiment.

The reproducing system includes a PUH 10, a preamp 11, a pre-equalizer 12, an amplitude control circuit 13, an ADC 14, an offset control circuit 15, an asymmetry control circuit 16, a PLL unit 17, an adaptive equalizer unit 22, and a reproducing unit 25.

Of these, the PLL unit 17 has a frequency detector 18, a phase comparator 19, a loop filter 20, and a VOC 21 as its detailed configuration.

The adaptive equalizer unit 22 has an FIR filter 23 and an equalization coefficient learning circuit 24 as its internal configuration.

The reproducing unit 25 has a Viterbi decoder 26, a synchronous demodulation circuit 27, and an ECC circuit 28 as its internal configuration.

The recording system has a modulation circuit 29 and a recording waveform generating unit 30.

The recording learning system has a reproduction-state determining unit 50, a recording learning unit 51, and a defect determining unit 54. The recording learning unit 51 has a recording compensation amount calculating circuit 52, and a learned-value memory 53 as its internal configuration.

The basic operation of the optical disc recording and reproducing apparatus 1 constructed as described will be described, starting with the reproducing system.

The PUH 10 has a built-in laser element (not shown). The PUH 10 radiates laser light to the optical disc 100 at the reproduction laser power, and detects reflected light from an optical disc medium to thereby output a reproduction signal.

The reproduction signal outputted from the PUH 10 is sent to the preamp 11 to undergo processing such as signal amplification, and subjected to waveform equalization in advance by the pre-equalizer 12. This waveform equalization characteristics may be configured by, for example, a high-order equiripple filter.

Subsequently, the signal that has been subjected to waveform equalization processing has its signal amplitude adjusted by the amplitude control circuit 13, and its input signal level value is converted into a digital value by the ADC 14.

As for the sampling clock of the ADC 14, a clock is extracted from the reproduction signal itself so that the sampling timing becomes appropriate. That is, a channel frequency is detected from the reproduction wave signal by the frequency detector 18, and a phase error from an ideal sampling point is detected by the phase comparator 19 for control.

This is a part generally referred to as PLL, and controlled by the same loop filter 20 together with a frequency control and a phase control, and the clock is supplied to the ADC 14 by a VCO 21.

If the optical disc 100 is a recordable medium such as HD DVD-R, because it is necessary to generate a clock for recording, a meandering pattern called a wobble is formed in a disk groove. Since the frequency of this wobble and the channel frequency are specified to be in a fixed ratio, if only frequency control is to be performed, this can be performed by using a wobble signal without performing extraction from the reproduction signal itself, and also high-precision frequency control can be performed. For this reason, this method is employed when performing reproduction from a recording medium.

The reproduction signal that has undergone AD conversion by the ADC 14 is subjected to digital waveform shaping by the offset control circuit 15 and the asymmetry control circuit 16.

The offset control circuit 15 controls the offset of a reproduction signal so that the signal-component duty ratio becomes constant. The asymmetry control circuit 16 detects the asymmetry in the amplitude direction of the reproduction signal whose offset has been adjusted, by performing average detection, for example, and controls the waveform of the reproduction signal so that the waveform becomes symmetrical with respect to the center value.

The reproduction signal that has undergone digital waveform shaping is then inputted to the adaptive equalizer unit 27, and waveform equalization processing is performed so that a response waveform corresponding to a predetermined partial response (PR) is obtained. The waveform equalization processing is performed by the FIR filter 23 having a predetermined number of taps. The tap coefficient used by the FIR filter 23 is generated by the equalization coefficient learning circuit 24.

While the configuration and operation of the adaptive equalizer unit 22 are known in the art, operation using the most common LMS algorithm will be described below.

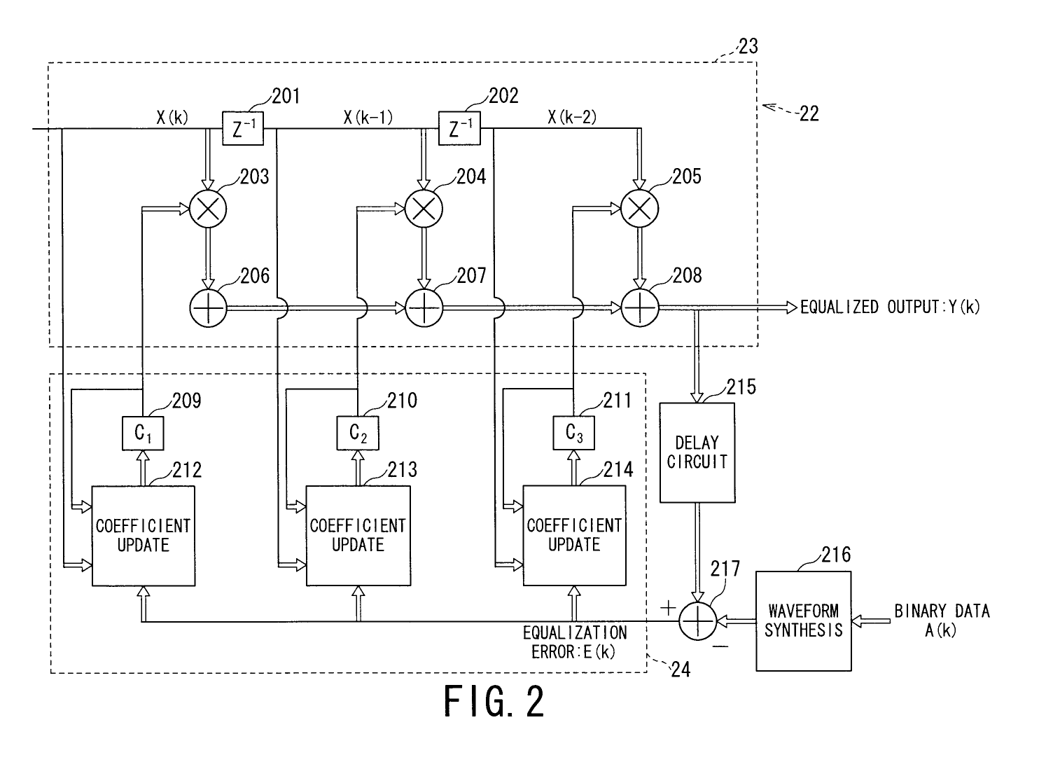

FIG. 2 is a block diagram showing an example of detailed configuration of the adaptive equalizer unit 22. The adaptive equalizer init 22 includes the FIR filter 23 and the equalization coefficient learning circuit 24. For the convenience of description, a part of the internal processing (equalization error generation) of the Viterbi decoder 26 is also shown in FIG. 2.

The FIR filter 23 includes clock delayers 201, 202 formed by flip-flops, multipliers 203, 204, 205, and adders 206, 207, 208. While FIG. 2 shows the FIR filter 23 of a three-tap structure using three multipliers, the number of taps is not particularly limited. Since the basic operation is the same even if the number of taps is increased, the following description will be directed to the three-tap structure shown in FIG. 2.

Assuming that an input signal at time k is x(k), and multipliers inputted to the multipliers 203, 204 and 205 are c1, c2 and c3, respectively, an output Y(k) of the adaptive equalizer unit 22 can be represented by the following equation.

Y(k)=x(k)*c1+x(k−1)*c2+x(k−2)*c3 (Equation 1).

Let the binary data obtained in the Viterbi decoder 26 with respect to Y(k) be A(k). Assuming that the target PR class is, for example, PR(3443), and A(k) is correct reproduction data, an original output Z(k) of the adaptive equalizer unit 22 at the time k is represented by the following equation.

Z(k)=3*A(k)+4*A(k−1)+4*A(k−2)+3*A(k−3)−7 (Equation 2).

In this case, an equalization error E(k) at the time k is defined by the following equation.

E(k)=Y(k)−Z(k) (Equation 3).

This equalization error E(k) is inputted to the equalization coefficient learning circuit 24, and the coefficients c1, c2, c3 of the respective multipliers 203, 204, 205 are adaptively learned by the equalization coefficient learning circuit 24. In the adaptive learning, the coefficients c1, c2, c3 of the respective multipliers 203, 204, 205 are updated in accordance with the following equations.

c1(k+1)=c1(k)−α*x(k)*E(k) (Equation 4)

c2(k+1)=c2(k)−α*x(k−1)*E(k) (Equation 5)

c3(k+1)=c3(k)−α*x(k−2)*E(k) (Equation 6)

α in (Equation 4) to (Equation 6) is an update coefficient, and set to a small positive value, for example, 0.01. The value of α is set large at the beginning of learning, and the value of α is decreased after the elapse of a predetermined period of time. Since malfunction due to noise or the like occurs when α is large, the value of α must be decreased to an appropriate value to achieve improved error rate.

In FIG. 2, a waveform synthesis circuit 216 performs the processing represented by (Equation 2). Further, in a delay circuit 215, the output Y(k) of an adding circuit 208 is delayed by a period of time equivalent to the processing time in the Viterbi decoder 26. Further, the processing represented by (Equation 3) mentioned above is performed in an adding circuit 217.

Coefficient update circuits 212, 213, 214 of the equalization coefficient learning circuit 24 respectively perform computations represented by (Equation 4) to (Equation 6), thereby updating the coefficients c1, c2, c3 of the respective multipliers 203, 204, 205. Registers 209, 210, 211 are registers into which the coefficients c1, c2, c3 are temporarily stored.

The reproduction signal (signal output adaptively equalized to the PR class) formed by such learning processing and having passed through the FIR filter 23 is finally subjected to the maximum likelihood sequence estimation (Viterbi decoding) according to the PR class in the Viterbi decoder 26, thus obtaining binary decoded data (binary data).

The binary data outputted by the Viterbi decoder is then inputted to the synchronous demodulation circuit 27. In HD DVD, a binary data string is recorded as data for every 1116 bits referred to as a frame. A synchronizing unit within the synchronous demodulation circuit 27 detects a 24-bit binary data string (SYNC code) indicating the start position of each frame, and generates a synchronized signal every 12 bits for the demodulation unit of the subsequent stage.

Next, in the case of ETM modulation, the demodulation unit within the synchronous demodulation circuit 27 demodulates the binary data of every 12 bits into 8-bit reproduction data in accordance with preset demodulation rules. Then, the signal (demodulated data) obtained as byte data is further inputted to the ECC circuit 28.

The ECC circuit performs an error correction process of correcting errors added due to defects or the like. The error-corrected reproduction data is outputted to an external host device, for example, a personal computer.

Next, description will be given of an overview of operation of the recording system. Recording data outputted from an external host device is subjected to code modulation to be modulated into a recording code by the modulation circuit 29. For example, in HD DVD, code modulation according to ETM modulation rules is performed.

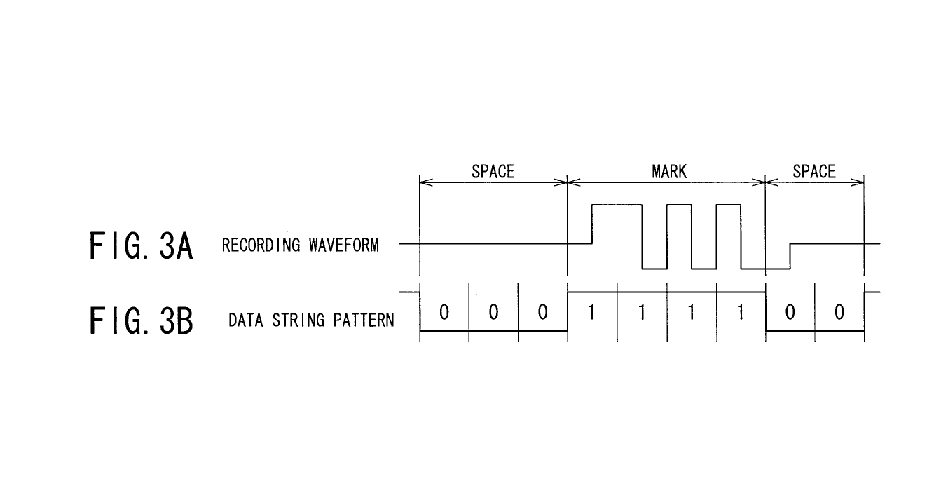

The recording data string that has undergone code modulation is inputted to the recording waveform generating unit 30. The recording waveform generating unit 30 generates a recording waveform for a laser diode (laser element) driver (LDD). FIG. 3B is a diagram showing an example of pattern of a data string inputted to the recording-wave generating unit 30, and FIG. 3A is a diagram showing an example of a recording waveform outputted from the recording-wave generating unit 30 in association with this data string.

As shown in FIG. 3A, normally, when forming a single continuous recording mark in an optical disc, laser light modulated by a recording waveform including a plurality of pulse strings is radiated to the recording layer. The waveform for this process is generated by the recording waveform generating unit 30.

Next, the basic operation of the recording learning system will be described. In the recording learning system, an index called a recording compensation amount Ec is calculated by the recording compensation amount calculating circuit 52, and parameters of a recording waveform are determined on the basis of the recording compensation amount Ec. Examples of parameters of a recording waveform include the pulse widths of the leading and trailing pulses of a plurality of pulses constituting the recording waveform.

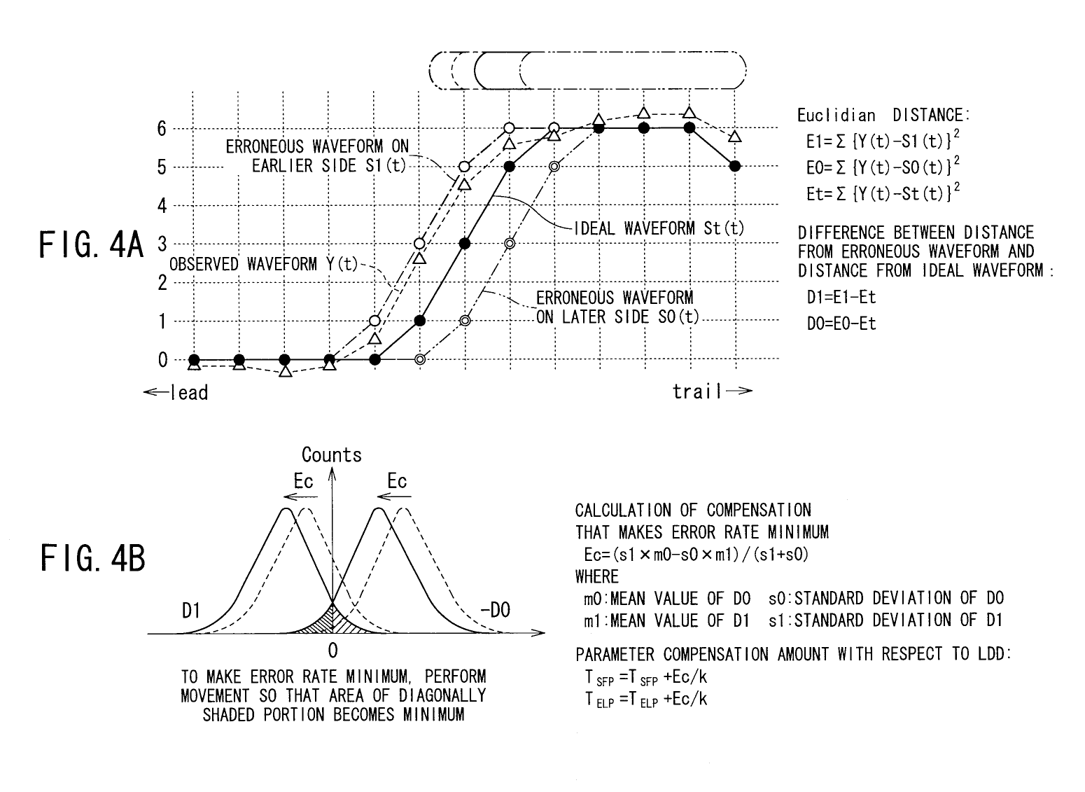

First, the recording compensation amount Ec and its calculation formula will be described with reference to FIGS. 4A and 4B. The calculation of the recording compensation amount Ec itself is basically the same as that disclosed in JP-A 2003-151219.

FIG. 4A is a diagram schematically showing the partial response waveform at the forward edge of a recording mark (the portion where a space changes to a mark).

The waveform Y(t) in FIG. 4A indicates the reproduction multilevel signal of this recording mark, and corresponds to the output waveform of the adaptive equalizer unit 22 in FIG. 1. The reproduction signal Y(t) (multilevel) is inputted to the Viterbi decoder 26, and binary data corresponding to Y(t) is outputted by a Viterbi decoding process. An ideal signal obtained by back calculation from this binary data (signal calculated by assuming an ideal partial response with respect to the binary data) is represented by St(t) in FIG. 4A.

On the other hand, S1(t) indicates an ideal multilevel signal that would be obtained from a pattern obtained assuming that the mark length was extended by T (hereinafter, referred to as the long pattern). Further, S0(t) indicates an ideal multilevel signal that would be obtained from a pattern obtained assuming that the mark length was shortened by T (hereinafter, referred to as the short pattern).

The Euclidean distances Et(t), E1(t), E0(t) between these three ideal reproduction signal strings St(t), S1(t), S0(t) and the obtained reproduction signal Y(t) are found from the following equations.

Et=√Σ{Y(t)−St(t)}² (Equation 7)

E1=√Σ{Y(t)−S1(t)}² (Equation 8)

E0=√Σ{Y(t)−S0(t)}² (Equation 9)

Where

Y(t): Reproduction signal amplitude after waveform equalization

St(t): Ideal signal amplitude found from the maximum likelihood decoding result

S1(t): Amplitude value of long pattern with respect to St(t)

S0(t): Amplitude value of short pattern with respect to St(t)

Et: Euclidean distance between Y(t) and St(t)

E1: Euclidean distance between Y(t) and S1(t)

E0: Euclidean distance between Y(t) and S0(t)

Further, differences between the above-mentioned Euclidean distances are defined by the following equations, with the long pattern error taken as D1 and the short pattern error taken as D0.

D1=E1−Et (Equation 10)

D0=E0−Et (Equation 11)

The above-mentioned Euclidean distance differences, the long pattern error D1 and the short pattern error D0, are found every time the reproduction data string undergoes a polarity change (a change from the mark “1” to the space “0”, and a change from the space “0” to the mark “1”), and with respect to D1 and D0 for every binary data in the vicinity of the polarity change point, mean values m1, m0 and their standard deviations s1, s0 are found. The recording compensation amount Ec is found from these values by the following equation.

Ec=(s1·m0−s0·m1)/(s1+s0) (Equation 12)

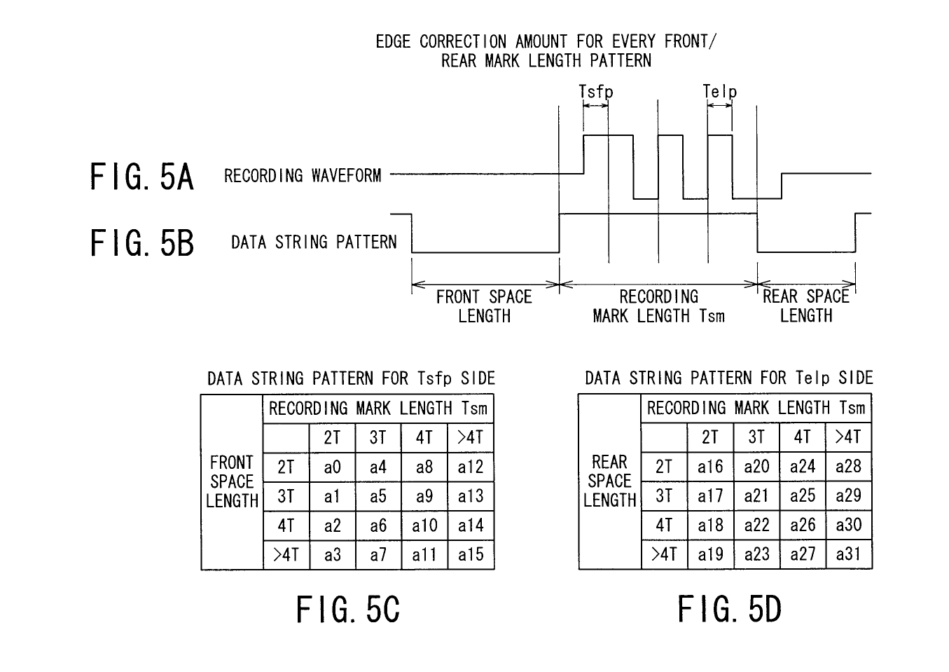

From the recording compensation amount Ec thus calculated, parameters related to the pulse width of a recording waveform are found by the following equations, for example. Here, parameters T_{sfp}, Tₑₗₚ are parameters of the recording waveform shown in FIG. 5A, of which T_{sfp} is a parameter related to the pulse width of the leading pulse, and Tₑₗₚ is a parameter related to the pulse width of the trailing pulse.

T_{sfp}=T_{sfp}+Ec/K (Equation 13)

Tₑₗₚ=Tₑₗₚ+Ec/K (Equation 14)

The parameters T_{sfp}, Tₑₗₚ are updated on the basis of (Equation 13) and (Equation 14), and converges when the recording compensation amount Ec becomes substantially zero.

The error rate at the time of this convergence becomes the smallest when assuming that the long pattern error D1 and the short pattern error D0 occur in accordance with the normal distribution (see FIG. 4B).

In the calculation of the recording compensation amount Ec, a statistical process of finding the mean value and the standard deviation with respect to each of the long pattern error D1 and the short pattern error D2 is performed. For this statistical process, observed values for a predetermined number of samples are required for a specific data string pattern.

This specific data string pattern includes a plurality of kinds of pattern depending on the combination of the length of a space in front of a change point from the space to a mark (the forward edge of a recording mark) and the length of the mark in rear of the change point.

FIG. 5C illustrates that there are 16 kinds of data string pattern from “a0” to “a15” as an example of data string pattern corresponding to the forward edge of a recording mark.

Likewise, FIG. 5D illustrates that there are 16 kinds of data string pattern from “a16” to “a31” as an example of data string pattern corresponding to the rear edge of a recording mark.

The recording compensation amount calculating circuit 52 classifies the reproduction data string outputted from the Viterbi decoder 26 into 16 kinds from “a0” to “a15”, calculates the recording compensation amount Ec from reproduction data of a predetermined number of samples for every reproduction data string thus classified, and finds the pulse width parameter T_{sfp} of the leading pulse at the forward edge of a recording mark from “Expression 13”. The parameter T_{afp} thus found is stored into the learned-value memory 53 in association with respective data string patterns.

Likewise, the recording compensation amount calculating circuit 52 classifies the reproduction data string outputted from the Viterbi decoder 26 into 16 kinds from “a16” to “a31”, calculates the recording compensation amount Ec from reproduction data of a predetermined number of samples for every reproduction data string thus classified, and finds the pulse width parameter Tₑₗₚ of the trailing pulse at the rear edge of a recording mark from “Expression 14”. The parameter Tₑₗₚ thus found is stored into the learned-value memory 53 in association with respective data string patterns.

On the other hand, the recording waveform generating unit 30 classifies the data string of recording data inputted from the modulation circuit 29 into data strings “a1” to “a31”, acquires the parameters T_{sfp}, Tₑₗₚ by referring to the learned-value memory 53, and generates a recording waveform (FIG. 5A) corresponding to a data string pattern (FIG. 5B) on the basis of these parameters. The laser element provided in the PUH 10 is driven by this recording waveform, forming a mark/space in the optical disc 100.

The number of samples (number of measurements) for each data string pattern is determined in advance, measurements are taken by an internal counter, and upon completion of the number of measurements for every data string pattern, measurement with that pattern is finished. The calculation of the recording compensation amount Ec is complete when the number of counts is reached for all the data string patterns. When updating parameters on the basis of (Equation 13), (Equation 14), this process is repeated.

As described above, observed values for a predetermined number of samples is required for calculation of the recording compensation amount Ec. In this regard, accurate observed values cannot be obtained if the phase locked loop of the PLL unit is locked off during the observation period or during pull-in of the phase locked loop, and the recording compensation amount Ec obtained as a result becomes erroneous as well. Accurate observed values cannot be obtained also when a defect is included in the reproduction signal of the optical disc 10.

As a means for avoiding these problems, the optical disc recording and reproducing apparatus 1 according to this embodiment of the present invention includes the reproduction state determining unit 50 and the defect determining unit 54. The operations of these units will be described below.

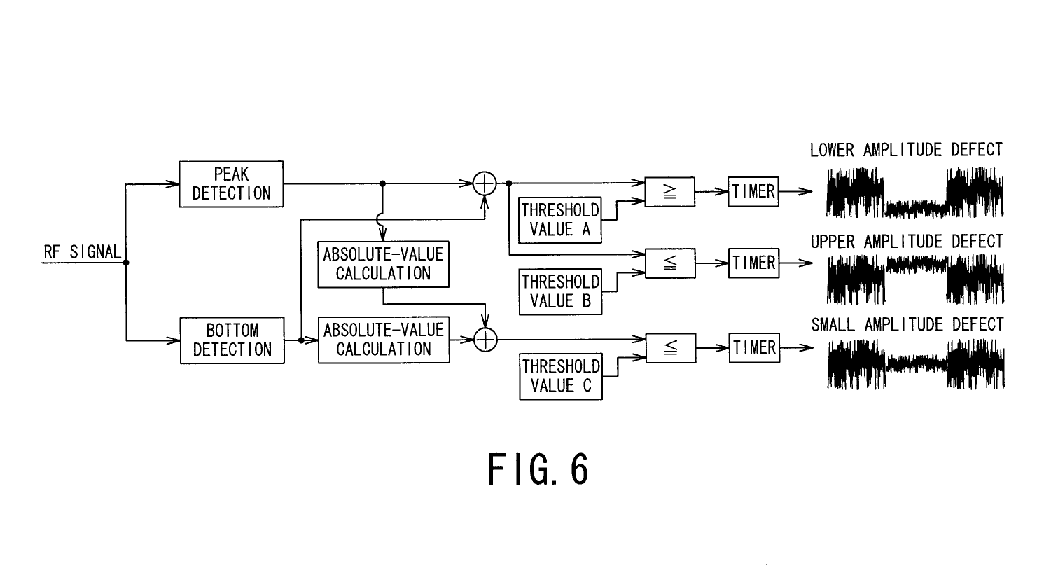

FIG. 6 is a diagram showing an example of configuration of the defect determining unit 54. The defect determining unit 54 can be configured to detect the peak value and bottom value of a reproduction signal envelope to thereby detect defects from these values. If the peak value and the bottom value are extremely small, this is regarded as a small amplitude defect. If the peak value and the bottom value are both large positive values, this is regarded as an upper amplitude defect (so-called light point defect or the like). Further, if the peak value and the bottom value are both large negative values, this is regarded as a lower amplitude defect (so-called black spot or the like).

Detection for these three kinds of defect is performed, and upon detecting any one of these defects, a “defect detection signal” is generated (OR processing).

The method using an envelope is merely an example, and a method using an equalization error signal or the like may be used as well. Upon detecting a defect component included in a reproduction signal, the defect determining unit 54 outputs the above-mentioned defect detection signal to the recording compensation amount calculating circuit 52.

On the other hand, the reproduction state determining unit 50 is a circuit for determining the state of stability from the continuity of a synchronizing signal (SINC code) detected by the synchronous demodulation circuit 27. Upon determining that the reproduction state is stable, the reproduction state determining unit 50 generates a stable reproduction state signal for output to the recording compensation amount calculating circuit 52.

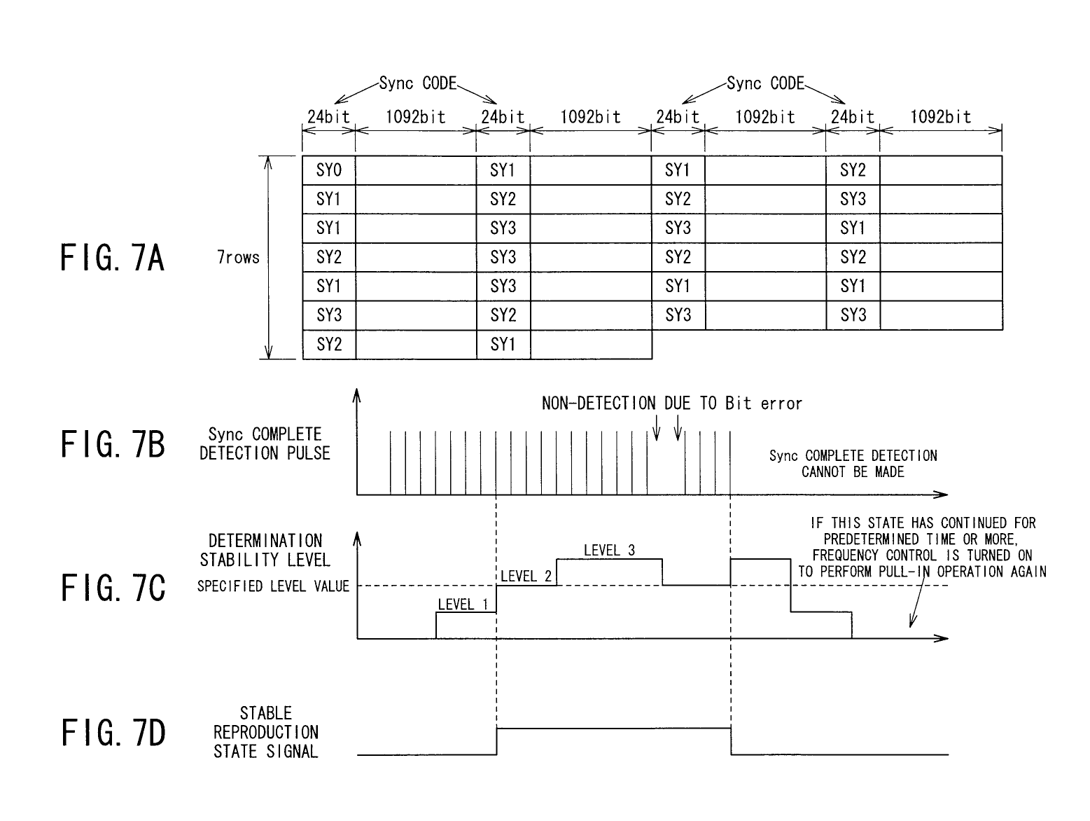

FIGS. 7A to 7D show an example of how the reproduction state determining unit 50 generates a stable reproduction state signal. FIG. 7A is a diagram showing the sector structure of record data of HD DVD. The sector is split into divisions including sync codes of 24 bits and data of 1092 bits. There are four kinds of Sync code, “SY0”, “SY1”, “SY2”, “SY3” as the Sync code provided at the beginning of each division. The synchronous demodulation circuit 27 compares these Sync codes with inputted reproduction data, and if they match completely, outputs a Sync complete detection signal (synchronizing signal) as shown in FIG. 7B to the reproduction state determining unit 50.

The reproduction state determining unit 50 sets an index called determination stability level, and performs a process of raising and lowering the determination stability level by judging the continuity of synchronous detection on the basis of the Sync complete detection pulse.

For example, four determination stability levels from level 0 to level 3 are provided, and the reproduction state is determined to be stable at level 1 or higher and a stable reproduction state signal (FIG. 7D) is generated.

Each determination stability level rises by 1 when Sync complete detection continues four consecutive times, for example, with level 3 being the upper limit. In the example shown in FIG. 7C, the determination stability level becomes level 2 at the time when Sync complete detection has continued eight consecutive times, and a stable reproduction state signal is outputted to the recording compensation amount calculating circuit.

Thereafter, Sync complete detection continues four more consecutive times, so the determination stability level rises to level 3, and a stable reproducing operation is continued.

On the other hand, when a temporary bit error occurs due to degradation of signal quality or the like, Sync complete detection does not occur, causing a dropout of the Sync complete detection pulse. For example, if the determination stability level is set to drop from level 3 to level 2 when Sync complete detection has not occurred even a single time, the determination stability level drops to level 2 at this point as shown in FIG. 7C. On the other hand, if the determination stability level is set to drop from level 2 to level 1 when Sync complete detection has not occurred four consecutive times, the determination stability level remains at level 2, and then Sync complete detection occurs four consecutive times so that the determination stability level rises to level 3 again.

The signal quality of the reproduction signal deteriorates only slightly during this period, and the reproduction signal is continuously sent to the recording compensation amount calculating circuit 52 for recording compensation amount calculation.

The last part of FIG. 7C illustrates a case where non-detection continues consecutively when the phase locked loop slips or the adaptive equalizer unit 22 diverges, for example.

In this case, even when at level 3, the determination stability level is set to drop to level 1 when the number of consecutive non-detection periods exceeds 4. Then, as shown in the drawing, the determination stability level drops from level 3 to level 1 at once. Since the determination stability level is lower than level 2, the stable reproduction state signal stops.

If non-detection further continues, the determination stability level drops to level 0, and if that state continues for a fixed period or time or longer, as the reproducing system, a pull-in operation is performed again from frequency control/phase control for recovery.

By determining the stable reproduction state in this way on the basis of the continuity of a synchronizing signal, it is possible to determine not only the stability of the PLL unit 17 but overall stability including the stability of the adaptive equalizer unit 22.

On the basis of a defect detection signal outputted from the defect determining unit 54, and a stable reproduction state signal outputted from the reproduction state determining unit 50, the recording compensation amount calculating circuit 52 performs a measuring operation with reproduction data obtained only “when no defect has been detected and the reproduction state is stable”. If a defect has been detected or if the stable reproduction state signal has not risen, inputting of two signals (equalized signal, decoded data) to the recording compensation amount calculating circuit 52 is stopped, and the counter is not counted up but put on hold.

When the system has recovered from a defect, and the stable reproduction state signal has risen, count-up is started again, and measurements are continued until completion of a predetermined number of observations.

As described above, with the optical disc recording and reproducing apparatus 1 according to this embodiment, divergence or erroneous convergence of the recording compensation amount Ec during PLL unlock or due to a defect is eliminated, thereby making it possible to perform recording compensation learning with high precision and stability.

### (2) OTHER EMBODIMENTS

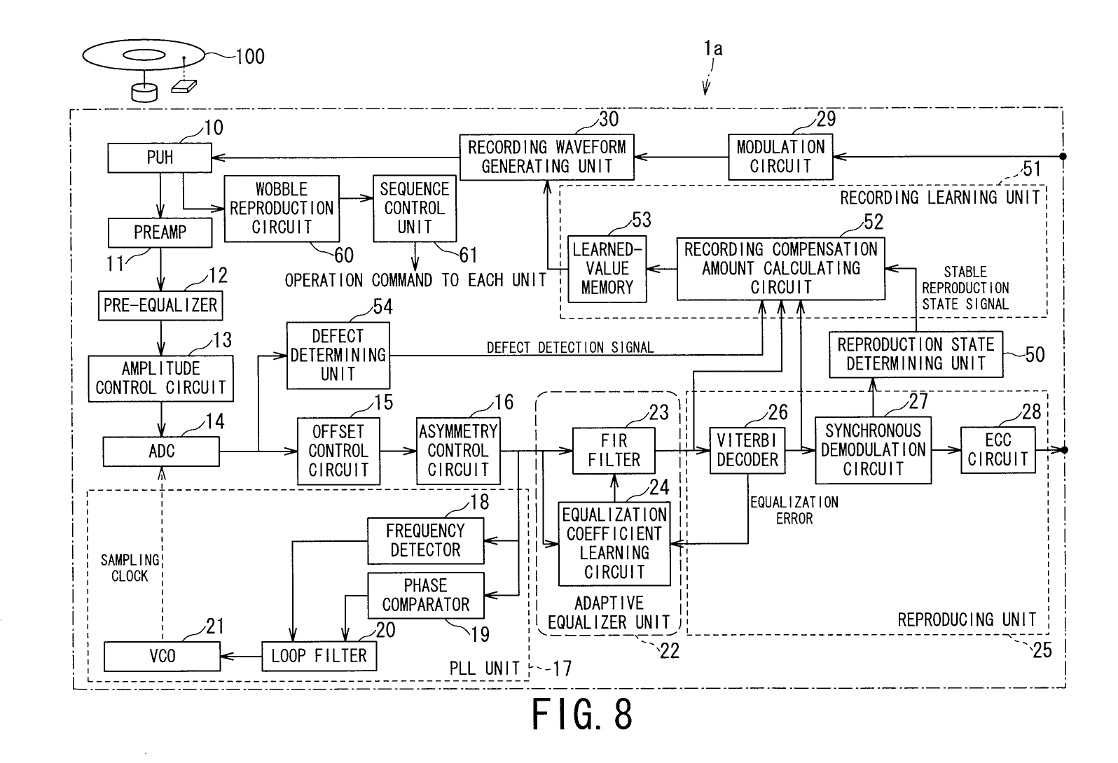

FIG. 8 is a diagram showing an example of configuration of an optical disc recording and reproducing apparatus 1a according to a second embodiment of the present invention. In the second embodiment, a wobble reproduction circuit 60 and a sequence control unit 61 are added to the configuration of the first embodiment.

According to the first embodiment, it is possible to avoid a situation where acquisition of recording learning data is performed when a defect has occurred or during an unstable state in which no synchronization is detected (due to PLL unlock or the like). However, as long as synchronization can be taken, recording learning is performed even in a period when a loop gain of PLL is high in a pull-in process, or even in a period when the gain (the coefficient α in (Equation 4) to (Equation 6)) of the adaptive equalizer unit 22 is high. Although such a high gain state provides fast response speed, it also results in increased noise components and hence is preferably avoided for the acquisition period of recording learning data.

In the second embodiment, when acquiring data for recording learning, the gain of the PLL unit 17 or the gain of the adaptive equalizer unit 22 is controlled by the sequence control unit 61.

Further, in the second embodiment, the area for recording/reproducing data for recording learning is divided more finely than the normal data recording and reproducing area.

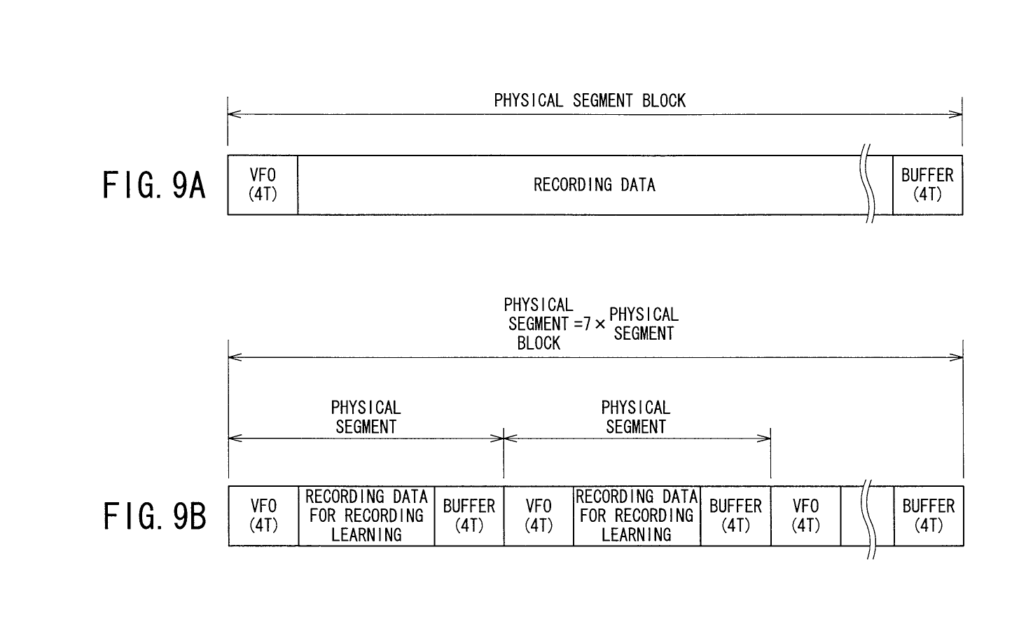

FIG. 9A illustrates a normal recording area unit of data specified by the HD DVD standard. The HD DVD standard specifies that recording be performed with respect to one physical area unit called a physical segment block. As for the recording data structure, a physical segment block is equivalent to one ECC block length. One physical segment block includes seven physical segments.

A VFO area including successive 4T patterns is provided at the leading end of one physical segment block, thus facilitating pull-in of PLL by reproduction of the VFO area. Further, a buffer area similarly including successive 4T patterns is provided at the trailing end of the physical segment block.

As shown in FIG. 9R, in this embodiment, data for recording learning is recorded/reproduced not in units of one physical segment block but in units of physical segments obtained by dividing the one physical segment block in seven. Further, a VFO area is provided at the leading end of each physical segment, and a buffer area is provided at the trailing end of each physical segment.

As a result, recording learning can be repeated seven times within one physical segment block. Further, by providing a VFO area and a buffer area, which are the same as the normal user data area, respectively at the leading and trailing ends of each physical segment and linking them to each other, it is possible to perform recording and reproducing of data for recording learning through substantially the same operation as the recording/reproducing operation of normal user data.

Since 4T patterns occur consecutively in the VFO area, the operation of the adaptive equalizer unit 22 becomes unstable in this area. For this reason, the sequence control unit 61 also performs control for preventing this.

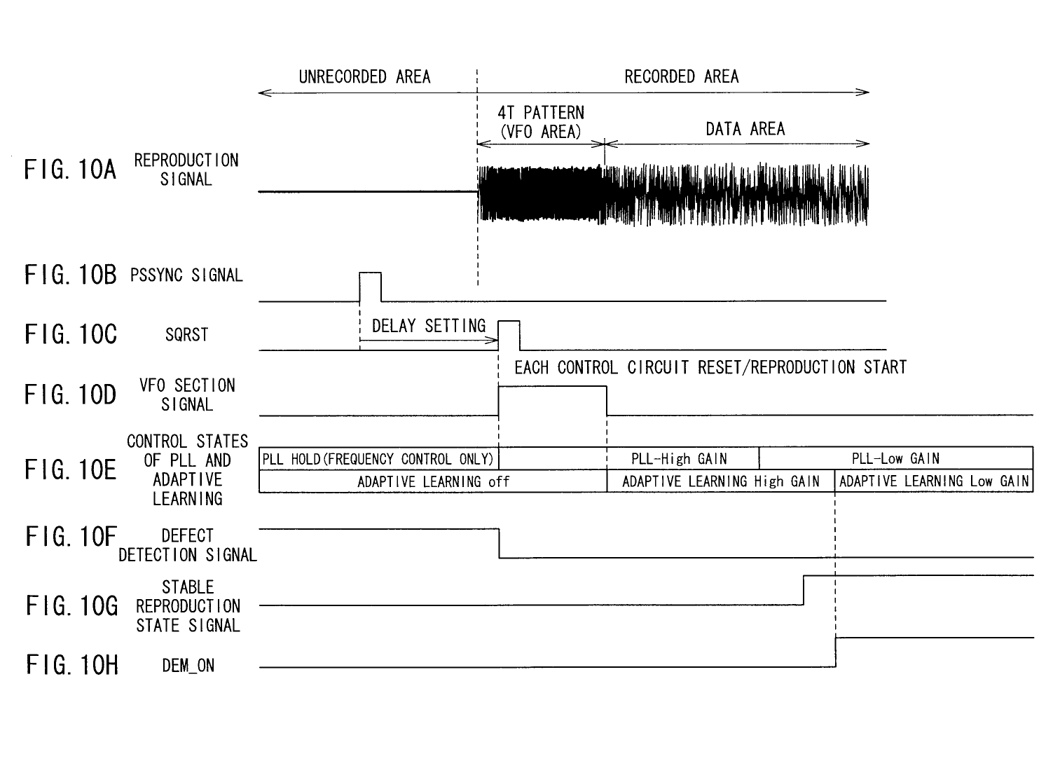

Now, operation of the sequence control unit 61 will be described with reference to FIGS. 10A to 10H.

FIG. 10A is a diagram showing the range from an unrecorded area to the leading end portion of a physical segment area in which data for recording learning is recorded.

The wobble reproduction circuit 60 extracts a wobble component from a difference signal outputted from the PUH 10, and performs WAP (Wobble Address in Periodic position) decoding. Since a physical address is recorded in a wobble signal in advance, by decoding the WAP modulated into a wobble signal, it is possible to identify the physical address of a physical segment on the optical disc 100.

The wobble reproduction circuit 60 outputs to the sequence control unit 61 the address (PS Block Address (PBA)) of the physical segment thus detected, and a synchronizing signal (Physical segment SYNC (PSSYNC) detection signal) indicating that a physical segment has been detected (see FIG. 10B).

The sequence control unit 61 issues a sequencer reset signal (SQRST) by delaying the PSSYNC signal of PBA in which recording learning data is written, the delay setting being determined in advance (see FIG. 10C). The reason for setting a delay is that the actual physical position where the VFO area exists is shifted by 24 Wobbles from the leading end of a PSblock as specified by the standard. The purpose of the SQRST signal is to serve as a signal for indicating the start of reproduction after resetting each control circuit and counter or the like.

Although the VFO area at the leading end of a physical segment provides an advantage of facilitating pull-in of PLL, it does not allow learning by the adaptive equalizer unit 22 because it is formed by repetition of 4T patterns. Accordingly, for the VFO area, “PLL-High gain, adaptive learning Off” is set (See FIGS. 10D and 10E). The width of the VFO section signal is set to a length of about 71 Bytes as specified by the standard.

Next, when the VFO section signal has fallen, learning of the adaptive equalizer unit 22 is started with High gain. After the VFO area ends, the record data for learning becomes random data without periodicity, so even with High gain, convergence in a short time is possible without divergence.

The period in which the gain of the PLL unit 17 is set high is measured by a counter for a fixed period of time from the start of SQRST determined in advance, and is dropped to Low gain upon reaching a specified time, thus preventing deterioration of signal quality. Lastly, the adaptive learning gain is dropped to Low gain, thus preventing deterioration of signal quality due to erroneous learning caused by noise or the like in this case as well.

By controlling the series of sequence by the sequence control unit 61 in this way, even when the recording area of data for recording learning is accessed from an unrecorded area, it is possible to stably perform pull-in of PLL of the PLL unit 17 and convergence of adaptive learning of the adaptive equalizer unit 22.

In addition to the conditions that (a) a defect detection signal has not risen and (b) a stable reproduction state signal has risen, the recording compensation amount calculating circuit 52 according to the second embodiment is controlled to perform measurement for recording compensation amount calculation only when (c) gains are controlled by the sequence control unit 61 such that PLL-Low gain and adaptive learning-Low gain. This timing is represented by “DEM_ON” signal shown in FIG. 10H.

Through such control of the recording compensation amount calculating circuit 52, it is possible to prevent 4T-4T pattern measurement (pattern measurement of “a10”, “a26” in FIG. 5C, 5D) from being completed with only periodic signals due to the succession of 4T patterns in the VFO area, and to calculate the recording compensation amount Ec with a stable signal quality.

The above-described sequence control scheme can be applied not only to the calculation of the recording compensation amount Ec for determining the pulse width such as Tsfp, Telp shown in FIG. 5A, but also to learning of other parameters of a recording waveform. For example, the above-described sequence control scheme can be applied to the learning of optimum recording power. In this case, the pulse amplitude of each pulse shown in FIG. 5A is the parameter to be learned.

A common, well-known calculation method for optimizing the recording power is a method of measuring the symmetry of a reproduction signal. In particular, the method that provides the highest precision is to measure the symmetry of every T (from 2T to 11T in the case of HD DVD), and determine the recording power so that the symmetry values of all Ts become substantially constant.

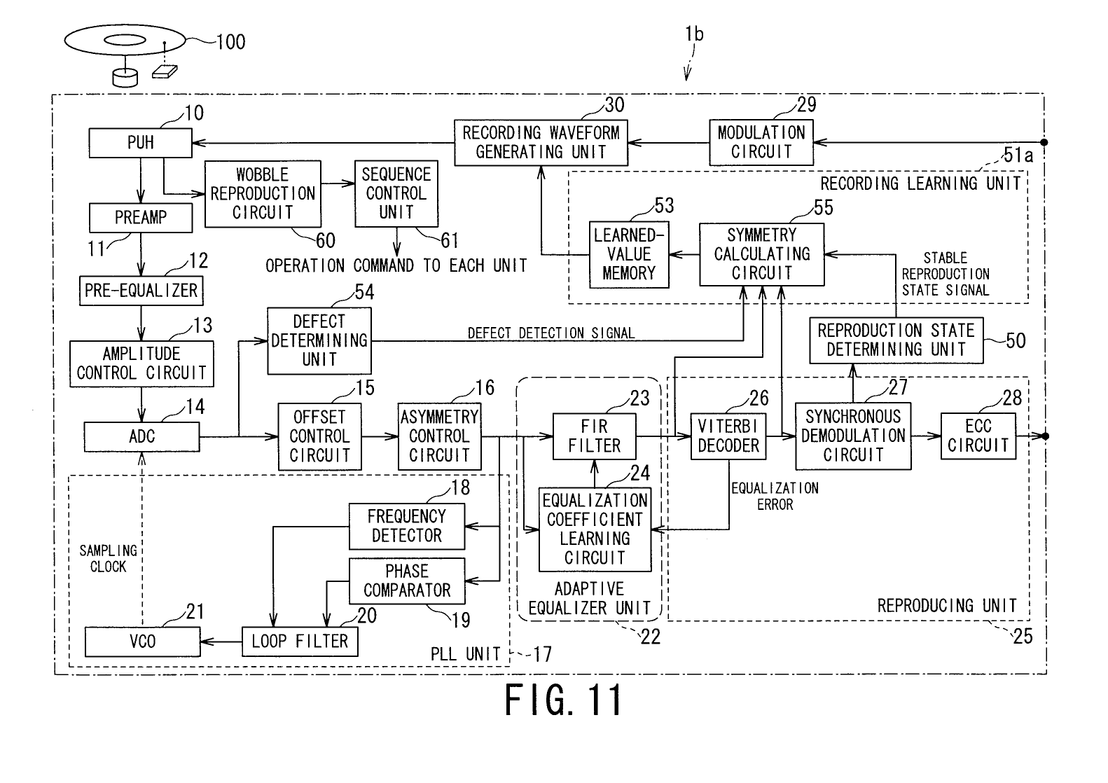

FIG. 11 shows an example of configuration of an optical disc recording and reproducing apparatus 1b configured for learning of recording power, with the recording compensation amount calculating circuit 52 shown in FIG. 8 replaced by a symmetry calculating circuit 55. This configuration makes it possible to perform symmetry calculation in a stable reproduction state in the same manner as in the calculation of the recording compensation amount Ec, thus enabling learning of recording power with high precision.

There are two conceivable methods for the learning sequence of the pulse width Tsfp, Telp or recording power. One is a method in which after learning data is recorded into a given physical segment, the data recorded in that physical segment is immediately reproduced, the parameter of the pulse width Tsfp, Telp or recording power is updated from the obtained recording compensation amount Ec or symmetry calculation result, learning data is recorded into the next physical segment with the updated parameter, and this process is repeated to bring the parameter to an optimum parameter.

Another is a method in which a parameter of the pulse width Tsfp, Telp or recording power is recorded onto the optical disc 100 while sequentially varying the parameter on a per physical segment basis, and thereafter the recorded data is sequentially reproduced from each physical segment for measurement, thereby selecting the optimum parameter.

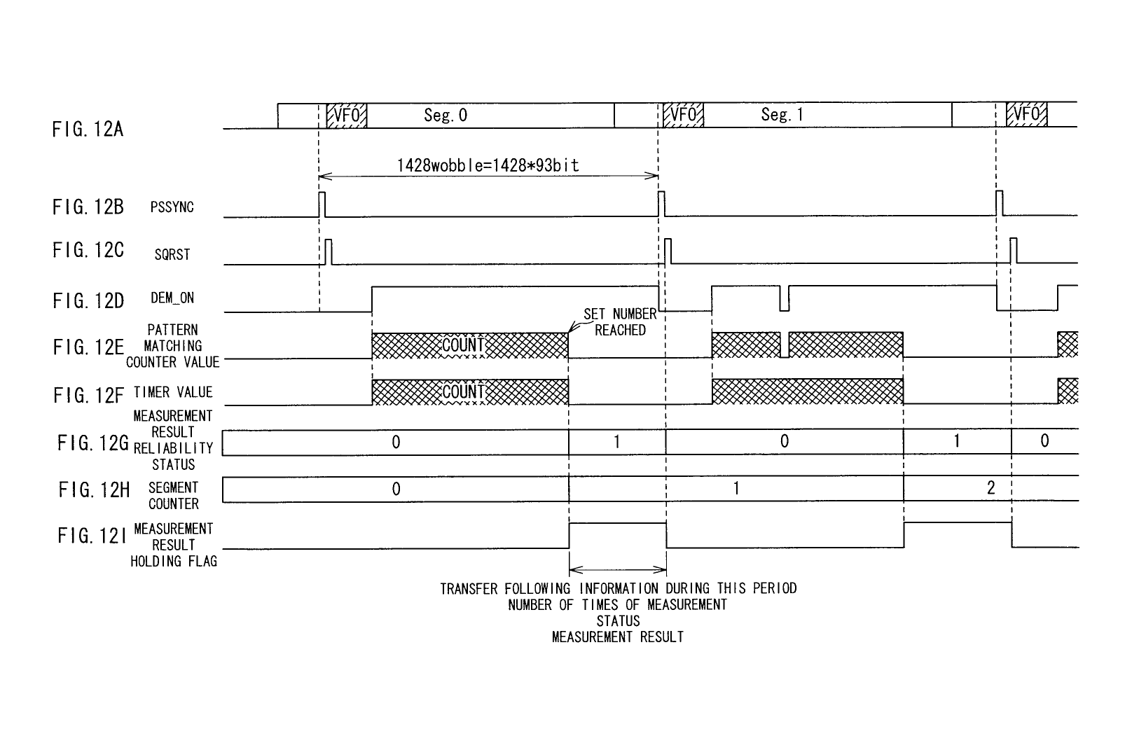

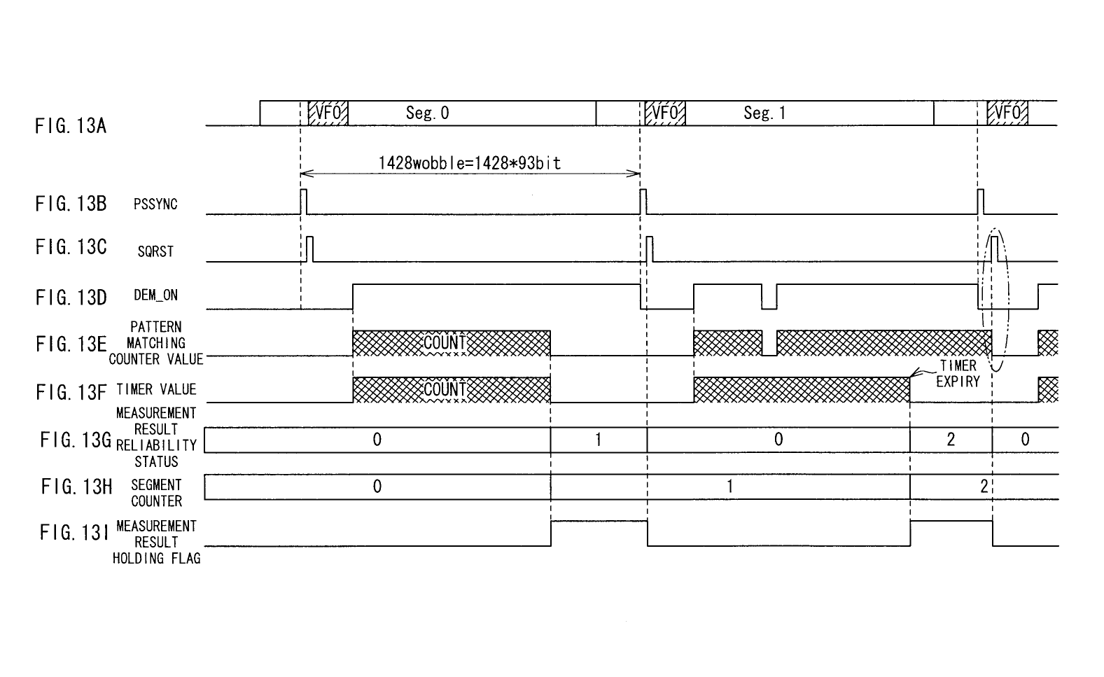

An embodiment of the present invention for realizing the latter sequential measurement will be described with reference to FIGS. 12A to 13I. In this embodiment, in addition to a counter for counting a measuring quantity, for example, a pattern matching counter required for calculating the recording compensation amount Ec, a timer counter for counting the elapsed time from the start of measurement is provided. Further, there are provided a flag indicating the status of reliability of the measurement result, a segment counter for counting the number of times of measurement on a per physical segment basis, and a measurement-result holding flag. The following control is performed by using these flags.

The process from reproduction of data for learning recording to generation of the SQRST signal through PSSYNC detection is the same as the process described above with reference to FIGS. 10A to 10C (FIGS. 12A to 12C).

The respective counters and flags other than the segment counter are all reset by the SQRST signal. Next, with the DEM_ON signal instructing the start of measurement as a trigger, counting of the pattern matching counter and time counter is started (FIGS. 12D to 12F).

When the pattern matching counter reaches a set number, the flag (reliability flag) indicating the status of reliability is set to “1”. When this flag is “1”, this means normal termination.

When this reliability flag becomes “1” (value other than “0”), the measurement-result holding flag is set to “1”, and the number of times of measurement, the status of reliability, and the measurement result (for example, the recording compensation amount Ec) are outputted during this period.

The respective counters and flags other than the segment counter are all reset by the next SQRST signal.

Normally, a predetermined number of patterns can be detected within the range of data volume that can be recorded in a single physical segment. Therefore, if normal reproduction data is obtained, as shown in FIG. 12G, the measurement result is outputted together with the reliability flag “1” indicating normal termination.

On the other hand, FIGS. 13A to 13I are diagrams showing abnormal termination. The reliability flag is configured to output Status “2” indicating abnormal termination when the timer counter reaches a set value. When a large number of defects are included in reproduction data, or when an unstable reproduction state continues for a relatively long period of time, the pattern matching counter is put on hold and not readily counted up, with the result that the timer counter reaches a set value before the pattern matching counter reaches a predetermined number. FIGS. 13A to 13I illustrates a situation where this abnormal termination has occurred in the second physical segment. In this case, the measurement result is outputted together with a reliability flag “2” indicating abnormal termination.

The reliability flag is referred to when using the measurement result, and the measurement result indicative of abnormal termination is discarded as being invalid. As a result, it is possible to realize a measuring operation of higher reliability.

As has been described above, with the optical disc recording and reproducing apparatus 1 and the optical disc recording and reproducing method according to this embodiment, in the optical disc recording and reproducing apparatus 1 in which the optimum parameter of a recording waveform with respect to an optical disc is determined by recording learning, data required for recording learning can be acquired in a stable reproduction state at all times.

It should to be noted that the present invention is not directly limited to the above-mentioned embodiments but can be embodied with its components modified in the implementation stage without departing from the scope of the present invention. Further, various embodiments of the invention can be realized by combining a plurality of components disclosed in the above-mentioned embodiments as appropriate. For example, of all the components disclosed in the embodiments, some components may be removed. Furthermore, components across different embodiments may be combined as appropriate.

What is claimed is:

1. An optical disc recording and reproducing apparatus which records data onto an optical disc and reproduces the data by a PRML scheme, comprising:
a recording waveform generating unit for generating a recording waveform for recording the data onto the optical disc;
a reproducing unit for reproducing the data recorded on the optical disc to generate reproduction data;
a defect determining unit for determining whether or not a defect is included in a reproduction signal of the optical disc;
a reproduction state determining unit for determining whether or not a reproduction state of the reproducing unit is stable; and
a recording learning unit for performing recording learning for determining, on the basis of the reproduction data, a parameter of a recording waveform generated by the recording waveform generating unit,
wherein the recording learning unit performs the recording learning on the basis of the reproduction data acquired when no defect is included in the reproduction signal and the reproduction state is stable.

2. The optical disc recording and reproducing apparatus according to claim 1, wherein:
the recording waveform is a waveform having a plurality of pulses; and
the parameter of the recording waveform is a parameter including at least one of a pulse width, a pulse position, and a pulse height of each of the pulses.

3. The optical disc recording and reproducing apparatus according to claim 1, wherein:
the reproduction state determining unit determines whether or not a reproduction state is stable on the basis of continuity of a synchronizing signal detected from the reproduction data.

4. The optical disc recording and reproducing apparatus according to claim 1, further comprising a sequence control unit for determining timing at which acquisition of the reproduction data for performing the recording learning is permitted, wherein:
the reproducing unit includes a PLL unit, and an adaptive equalizer unit for adapting the reproduction data to a partial response of a desired class;
the sequence control unit
detects a leading end of a learning data recording area on the basis of a predetermined address at which data for the recording learning is recorded,
sets a loop gain of the PLL unit high and turns off adaptive processing of the adaptive equalizer unit after the leading end is detected,
turns on adaptive processing of the adaptive equalizer unit and sets its loop gain high after reproduction of a VFO area, which extends continuous from the leading end over a predetermined range, is finished,
sets respective loop gains of the PLL unit and the adaptive equalizer unit low after elapse of a predetermined reproduction time from the leading end, and
thereafter permits acquisition of the reproduction data for performing the recording learning; and
the recording learning unit performs the recording learning on the basis of reproduction data acquired after acquisition of the reproduction data is permitted by the sequence control unit.

5. The optical disc recording and reproducing apparatus according to claim 4, further comprising a timer for measuring a predetermined learning time limit, after acquisition of the reproduction data is permitted by the sequence control unit,
wherein when an acquisition period of the reproduction data for the recording learning exceeds the learning time limit, the recording learning unit invalidates reproduction data acquired during the acquisition period.

6. An optical disc recording and reproducing method for recording data onto an optical disc and reproducing the data by a PRML scheme, comprising the steps of:
(a) generating a recording waveform for recording the data onto the optical disc;
(b) reproducing the data recorded on the optical disc by a reproducing unit to generate reproduction data;
(c) determining whether or not a defect is included in a reproduction signal of the optical disc;
(d) determining whether or not a reproduction state of the reproducing unit is stable; and
(e) performing recording learning for determining, on the basis of the reproduction data, a parameter of a recording waveform generated by the step (a),
wherein in the step (e), the recording learning is performed on the basis of the reproduction data acquired when no defect is included in the reproduction signal and the reproduction state is stable.

7. The optical disc recording and reproducing method according to claim 6, wherein:
the recording waveform is a waveform having a plurality of pulses; and
the parameter of the recording waveform is a parameter including at least one of a pulse width, a pulse position, and a pulse height of each of the pulses.

8. The optical disc recording and reproducing method according to claim 6, wherein:
in the step (d), whether or not a reproduction state is stable is determined on the basis of continuity of a synchronizing signal detected from the reproduction data.

9. The optical disc recording and reproducing method according to claim 6, wherein:
the reproducing unit includes a PLL unit, and an adaptive equalizer unit for adapting the reproduction data to a partial response of a desired class;
the optical disc recording and reproducing method further comprises the step (f) of determining timing at which acquisition of the reproduction data for performing the recording learning is permitted;
the step (f) includes the steps of
detecting a leading end of a learning data recording area on the basis of a predetermined address at which data for the recording learning is recorded,
setting a loop gain of the PLL unit high and turns off adaptive processing of the adaptive equalizer unit after the leading end is detected,
turning on adaptive processing of the adaptive equalizer unit and sets its loop gain high after reproduction of a VFO area, which extends continuous from the leading end over a predetermined range, is finished,
setting respective loop gains of the PLL unit and the adaptive equalizer unit low after elapse of a predetermined reproduction time from the leading end, and
thereafter permitting acquisition of the reproduction data for performing the recording learning; and
in the step (e), the recording learning is performed on the basis of reproduction data acquired after acquisition of the reproduction data is permitted in the step (f).

10. The optical disc recording and reproducing method according to claim 9, further comprising the step of measuring a predetermined learning time limit after acquisition of the reproduction data is permitted by the sequence control unit,
wherein in the step (e), when an acquisition period of the reproduction data for the recording learning exceeds the learning time limit, reproduction data acquired during the acquisition period is invalidated.
